(19) United States
(12) Patent Application Publication
(10) Pub. No.: US 2020/0113348 A1
(43) Pub. Date: Apr. 16, 2020

(54) MODULAR SLEEP SOLUTION

(71) Applicants: Audrey Dorfman, San Francisco, CA (US); Michelle Muhme, San Francisco, CA (US)

(72) Inventors: Audrey Dorfman, San Francisco, CA (US); Michelle Muhme, San Francisco, CA (US)

(21) Appl. No.: 16/708,183

(22) Filed: Dec. 9, 2019

Related U.S. Application Data
(62) Division of application No. 15/851,034, filed on Dec. 21, 2017.
(60) Provisional application No. 62/437,621, filed on Dec. 21, 2016.

(51) Int. Cl. A47C 27/14; A47C 27/12; A47C 27/00; A47C 31/12; A47C 27/08; A47C 21/00; A47C 21/04

(52) U.S. Cl. CPC A47C 27/146; A47C 27/12; A47C 27/148; A47C 27/001; A47C 31/123; A47C 27/08; A61H 2201/0146; A47C 21/046; A47C 27/124; A47C 27/121; A47C 21/048; A47C 27/002; A47C 21/006

(57) ABSTRACT

A modular sleep apparatus that enables customization of a conventional mattress. The modular sleep apparatus includes a customizable mattress pad casing having pockets into which various inserts may be placed. The more the number of pockets, the greater customization the mattress pad allows. The inserts themselves can be of varying thickness, firmness, and material. In some embodiments, the inserts may also be placed directly over a conventional mattress and held in place with a fitted sheet. In other embodiments, the inserts are placed directly into pockets or envelopes in the top layer of a mattress. In other embodiments, the mattress pad casing is pre-assembled with inserts.

### CROSS REFERENCE TO RELATED APPLICATIONS

This application is a divisional of U.S. patent application Ser. No. 15/851,034, filed Dec. 21, 2017, which claims priority to U.S. Provisional Patent Application Ser. No. 62/437,621, filed Dec. 21, 2016. The aforementioned applications are incorporated herein by reference in their entirety.

### RELATED FIELD

Various embodiments relate generally to sleep apparatuses. More specifically, various embodiments relate to a modular sleep solution that offers an affordable and adaptable customized bedding solution.

### BACKGROUND

When two users share a mattress, their comfort preferences and needs often diverge. One user might prefer a soft mattress; the other might prefer a firm mattress. Even with a single user, his or her preferences may change daily. For instance, after a particularly strenuous workout, the user might desire more support from a particular area of the mattress but may prefer a soft mattress on an average night. Consumers want a way to meet their evolving needs, but because of the high cost of mattresses, they are reluctant to replace them frequently.

Consumers who want area-specific customization of their mattresses must purchase an adjustable mattress that costs thousands of dollars. While consumers can use commercially available and affordable mattress pads to customize their mattresses, these pads are of uniform thickness and material across the entire bed, and do not allow for individualized customization of different areas of the mattress.

The Sleep Number® bed is one of the most well-known customizable mattresses available on the market. It is priced well into the thousands, but its customization options are limited to adjusting the firmness of the mattress. Moreover, the Sleep Number® mattress has mechanical and electric parts, which makes it susceptible to breakdowns and malfunctions. Another shortcoming of this mattress is that it requires a platform base and cannot be used with the most common slatted and box spring bases. Other adjustable beds and mattresses available today have similar deficiencies. While mattress pads can be used to alter and customize mattresses, are affordable, do not have mechanical parts, and can be used with any bed and mattress, they do not allow customization to the same extent as adjustable beds. They also do not allow for customization of different areas of the mattress.

### SUMMARY

Embodiments of the invention concern a modular sleep solution with inserts suitable for placement on top of a conventional mattress. The modular sleep solution may include a customizable mattress pad casing having pockets into which various inserts may be placed. The more the number of pockets, the greater customization the mattress pad allows. The inserts themselves can be of varying thickness, firmness, and material. In a second embodiment, the inserts may also be placed directly over a conventional mattress and held in place with the help of a fitted sheet. A third option is for the inserts to be inserted directly into pockets or envelopes in the top layer of a mattress.

In some embodiments, the customizable mattress pad entirely envelopes all sides of the mattress, except for the bottom. The customizable mattress pad may be made from any material suitable for bedding, e.g., cotton, wool. In some embodiments, the upper surface of the mattress pad that comes in contact with the bedsheet may be made of a waterproof material. The customizable mattress pad may have four corners and either two or four sides fitted with elastic to keep it from slipping from its position over the mattress and so that it may be stretched taut over the mattress. In some embodiments, the mattress pad sits only on top of the mattress.

### BRIEF DESCRIPTION OF THE DRAWINGS

FIG. 1 shows the modular sleep system inserts placed directly over a conventional mattress and held in place by a fastening mechanism.

FIG. 2 shows the mattress pad of the invention with two pre-assembled customized pad areas, fitted over a conventional mattress.

FIG. 3 shows the customizable mattress pad of the invention with two customizable areas where inserts may be placed, with openings positioned at the bottom end of the mattress.

FIG. 4 shows the customizable mattress pad of the invention with two customizable areas where inserts may be placed, with openings positioned along the sides of the mattress.

FIG. 5 shows the customizable mattress pad of the invention with two customizable areas where inserts may be placed, with openings down the middle of each area.

FIG. 6 shows the customizable mattress pad of the invention with six customizable areas alongside one another where inserts may be placed, with openings positioned along the sides of the mattress.

FIG. 7 shows the customizable mattress pad of the invention with two customizable areas and a flap opening encompassing the entire mattress.

FIG. 8 shows the customizable mattress pad of the invention with two customizable areas and allowing for two or more inserts per area stacked on top of one another.

FIG. 9 shows a side view of the invention with two customizable areas.

FIG. 10 shows side view of the customizable mattress pad of the invention with two customizable areas and allowing for two or more inserts per area stacked on top of one another.

FIG. 11 shows a side view of the customizable mattress pad of the invention with interlocking inserts.

FIG. 12 shows the customizable mattress pad of the invention where inserts are placed into the pad through a slit opening at the center of the mattress pad casing.

### DETAILED DESCRIPTION

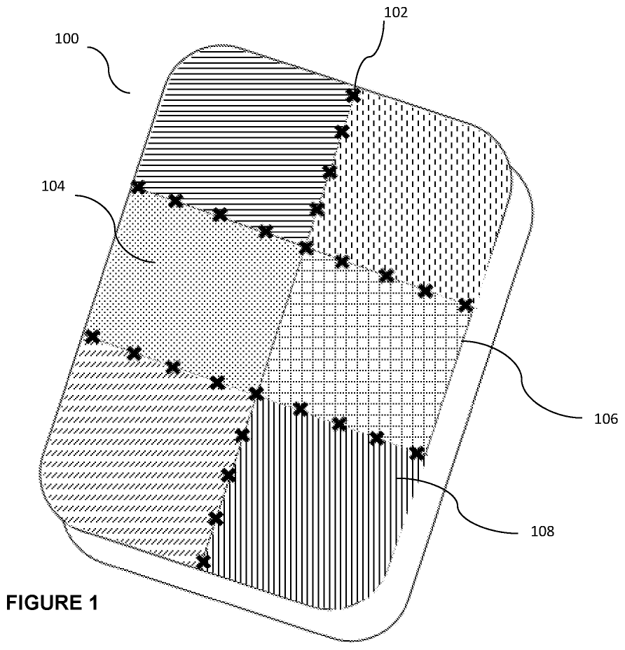

FIG. 1 shows the modular sleep solution 100 with inserts 104 and 108 placed over a conventional mattress 106. The inserts may be held in place using an unobtrusive mechanism 102 such as snaps, buttons, Velcro®, etc. The inserts 104 and 108 themselves are filled with different materials, e.g., down filling for softness, coir or latex for more firm support, a cooling gel, such as a phase-change material, to keep the user cool on warm nights. In one embodiment, the inserts are inflatable. The inflatable inserts are fitted with a one-way air valve such that air can easily enter the insert but not leave it. Before being placed on the mattress, the inserts are inflated according to the user's preferences. An almost full inflatable insert provides firm support, whereas a less full insert provides softer support. The inserts may also be inflated manually by the user before or after they are placed onto a mattress using a remote controlled or automatic inflator.

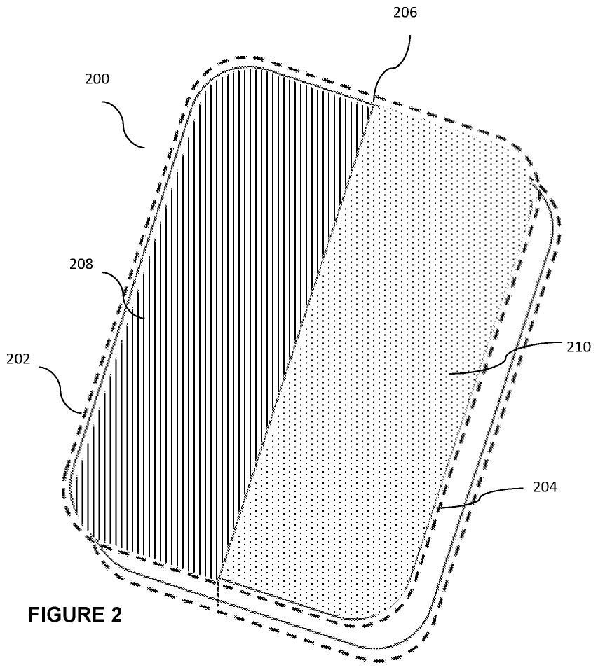

FIG. 2 shows a customizable mattress pad 200 fitted over and around a conventional mattress. In the embodiment shown in FIG. 2, a customizable mattress pad 200 includes two inserts 208 and 210 placed in pockets 202 and 204 separated by a seam 206. The customizable mattress pad 200 may be pre-assembled with a set of inserts selected by the user. The seam 206 may therefore be made of reinforced stitching using an upholstery thread made of, for instance, bonded nylon or bonded polyester. In some embodiments, the inserts 208 and 210 have interlocking shapes to keep them from shifting so not to require an inner seam to separate the pockets. The inserts 208 and 210 are represented by different patterns in FIG. 2 to allow the reader to distinguish between the two inserts, but can appear the same in practice. In some embodiments, the mattress casing is pre-assembled to hold only one insert along one side of the bed so that the other side does not add any padding to the mattress.

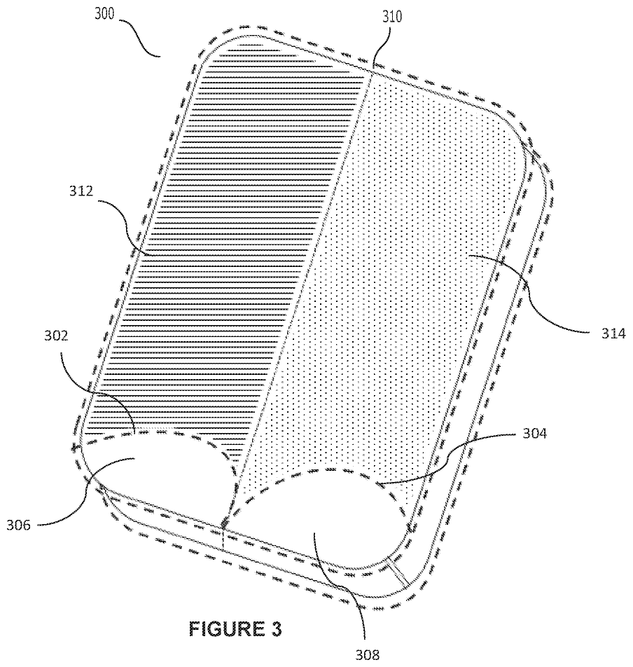

FIG. 3 shows one embodiment of a customizable mattress pad 300 fitted over and around a mattress, with two pockets 302 and 304. The pockets 302 and 304 have openings near the bottom edge of the mattress in the form of slits 306 and 308. The pockets are separated by seam 310, similar to the seam 206 in FIG. 2. A user can place inserts 312 and 314 into the pockets through the slits 306 and 308. The pockets may have openings to sides, the top, or the bottom of the customizable mattress pad. The inserts 312 and 314 themselves are filled with different materials, e.g., down filling for softness, coir or latex for more firm support, a cooling gel, such as a phase-change material, to keep the user cool on warm nights. In one embodiment, the inserts are inflatable. The inflatable inserts are fitted with a one-way air valve such that air can easily enter the insert but not leave it. Before being placed in the customizable mattress pad casing, the inserts are inflated according to the user's preferences. An almost full inflatable insert provides firm support, whereas a less full insert provides softer support. The inserts may be inflated manually by the user before they are placed into the customizable mattress pad 300, or after, using a remote controlled or automatic inflator. In another embodiment, the inserts include a motor for introducing vibrations. A user may use vibrating inserts for relieving muscle aches or for relaxation. The casing covering the inner filling of the insert may be made of a material similar to the material of the customizable mattress pad 300, e.g., cotton, wool. Once the inserts 312 and 314 are placed inside the pockets 302 and 304, the pockets may be temporarily sealed using closure mechanisms, e.g., buttons, zippers, hooks Velcro®.

The customizable mattress pad also allows for certain pockets to remain empty while insert pads are placed in other pockets. For instance, when two users are sharing a mattress, one user might want an insert pad placed in the customizable mattress pad casing, while the other user might prefer the mattress as is. The inserts themselves sit sandwiched between two layers of the customizable mattress pad casing 300. As explained in FIG. 3, each insert may be filled with one of several different materials. The top layer of the customizable mattress pad is in contact with a bedsheet and the bottom layer is in contact with a mattress.

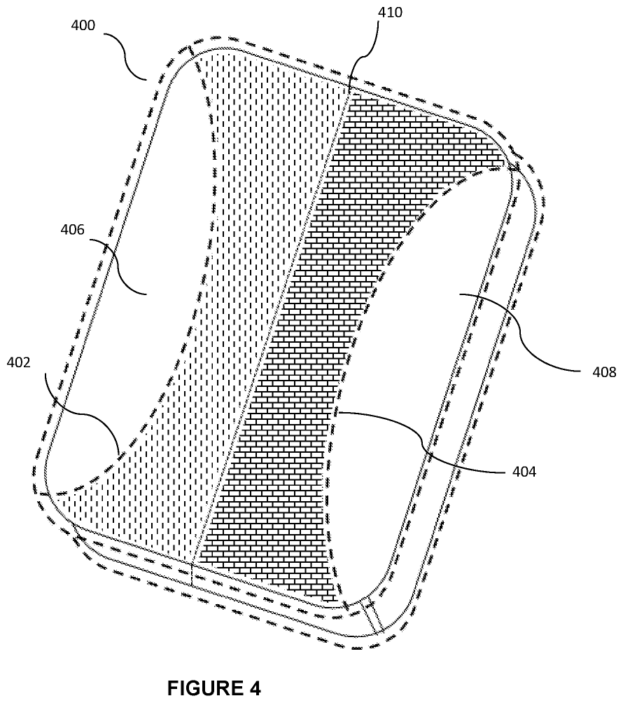

FIG. 4 shows a customizable mattress pad 400 fitted over and around a mattress, with two pockets 402 and 404. The pockets 402 and 404 have openings along the outer seam of the customizable mattress pad 400. The user can place inserts into the pockets through the slits 406 and 408. As in FIG. 2, a seam 410 keeps the insert in one pocket from shifting into the other pocket. As explained in FIG. 3 above, each insert may be filled with one of several different materials. Once the inserts are in place, the pockets are closed using closure mechanisms, e.g., buttons, zippers, hooks, or Velcro®.

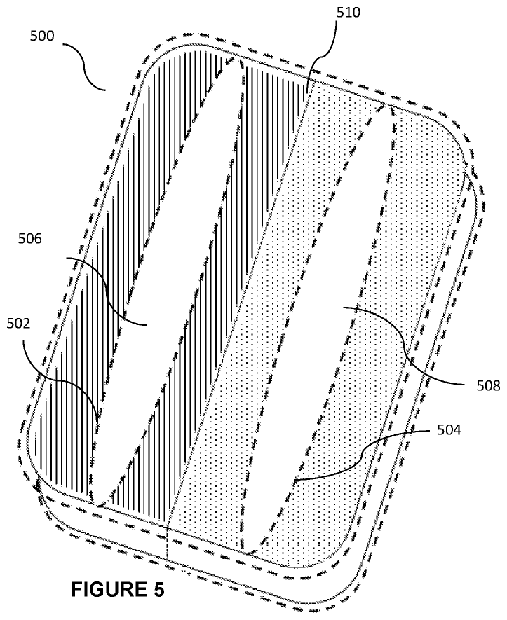

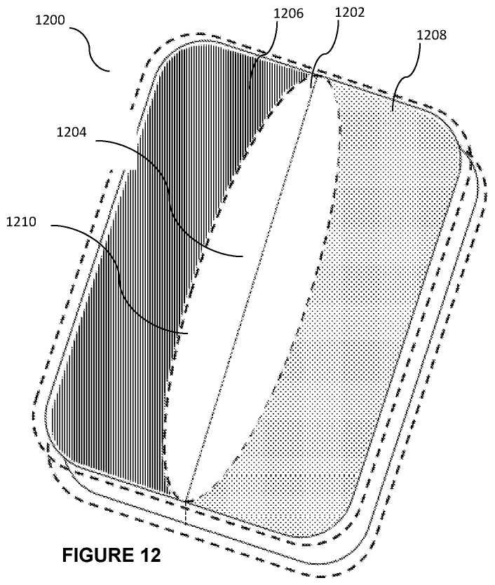

FIG. 5 shows yet another embodiment of a customizable mattress pad 500 fitted over and around a mattress, with two pockets 502 and 504. The pockets 502 and 504 have slit openings 506 and 508 in the middle of each pocket. As in FIG. 2, a seam 510 keeps the inserts from shifting from one pocket into the other. As explained in FIG. 3 above, each insert may be filled with one of several different materials. Once the inserts are in place, the pockets are closed using an unobtrusive closure mechanism that will not discomfort the user sleeping on the mattress e.g., flat snap buttons, Velcro®. A similar embodiment in FIG. 12 has a slit opening 1210 along the center of the customizable mattress pad 1200 running parallel and above the seam 1202. Inserts 1206 and 1208 are placed into the pocket 1204 separated by the seam 1202 through the slit opening 1210. As explained in FIG. 3 above, each insert may be filled with one of several different materials.

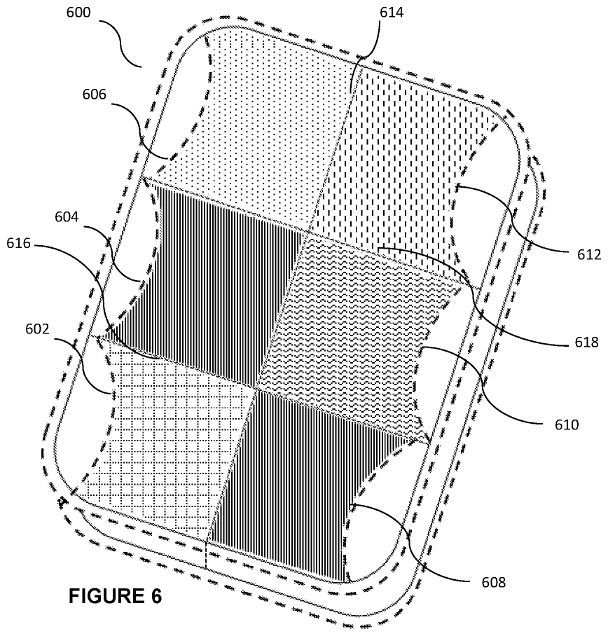

FIG. 6 shows a customizable mattress pad 600 fitted over and around a mattress, with multiple pockets, in this case six pockets 602-612. A customizable mattress pad 600 may have greater or fewer pockets. The pockets 602-612 can hold inserts made of an assortment of materials. For instance, a user might want a cooling gel insert near the bottom of the mattress where the feet rest, a supportive firm insert in the area where the spine rests, and a soft insert where the head rests. The user can then insert the cooling gel insert in the lowermost pocket 602, a coir insert in the middle pocket 604, and a soft down feather insert in uppermost pocket 606. The variety of inserts in FIG. 6 are represented through the use of different patterns to allow the user to distinguish between the various inserts, but the inserts may appear the same in practice.

Each of the pockets is isolated by a seam 614 running top to bottom and two seams 616 and 618 running across. The number of seams will vary according to the number of pockets desired. In an embodiment with eight pockets, there will be one seam running top to bottom and three seams running across. Each pocket in FIG. 6 has a slit opening through which the insert is put into place in the customizable mattress pad casing. As explained in FIG. 3 above, each insert may be filled with one of several different materials. The openings to the pockets may be in various locations including, but not limited to, along the center seam running top to bottom. For instance, the opening for one pocket 608 may be moved to the bottom end of the mattress and the opening for another pocket 612 may be moved to the top end of the mattress. Once an insert is in place, it is secured in its position by fixed seams on three sides and temporary closure mechanisms, e.g., buttons, zippers, hooks, Velcro®, on the fourth side.

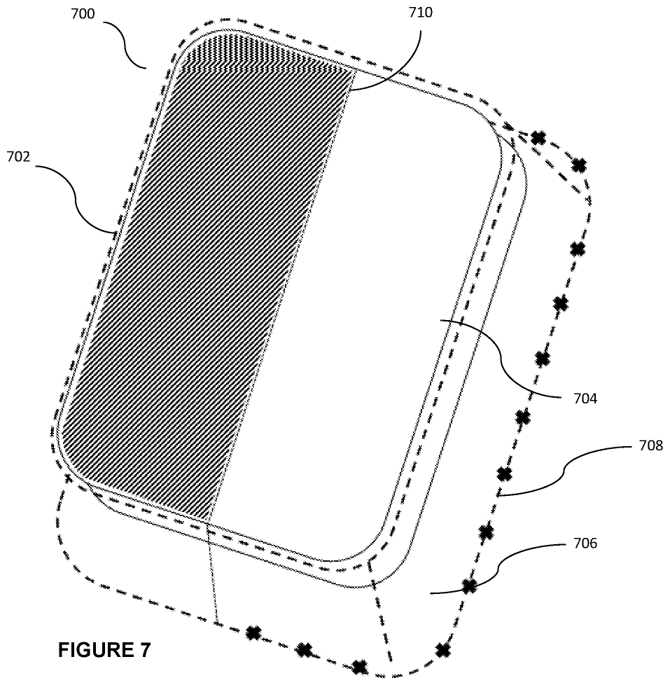

FIG. 7 shows a customizable mattress pad casing 700 with two pockets 702 and 704. The customizable mattress pad 700 entirely envelopes the mattress and wraps around the bottom of the mattress. Instead of slit openings through which inserts may be placed within the customizable mattress pad 700, this embodiment features flaps 706 on either side that may be lifted away to place the inserts within the pad 700. As explained in FIG. 3 above, each insert may be filled with one of several different materials. Once the inserts are in place, the flap 706 is brought down and secured to bottom of the customizable mattress pad using a clasping mechanism 708 e.g., snaps, buttons, eyelets, hooks, Velcro®. The portion of the customizable mattress pad 700 around the sides of the mattress may include an elastic material to pull the customizable mattress pad 700 taut around the mattress. The seam 710 is similar to the seam described in FIG. 2 and keeps the insert in one pocket from slipping into the adjacent pocket.

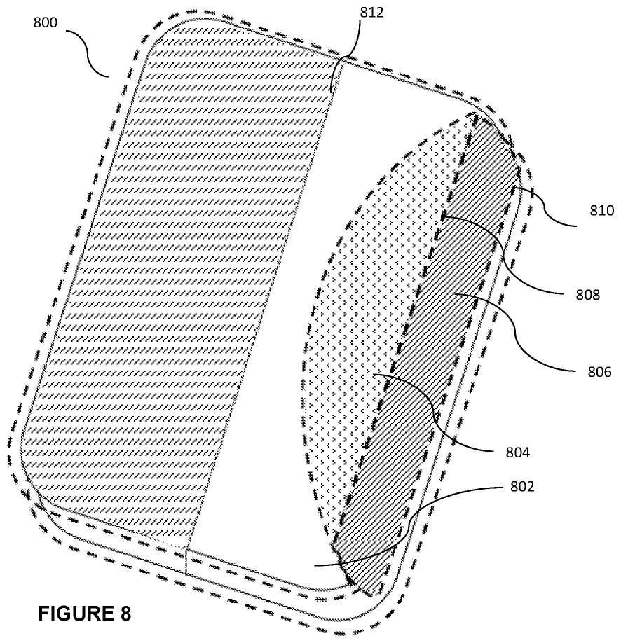

FIG. 8 shows a customizable mattress pad 800 with a double-insert configuration where each pocket 802 accommodates two or more inserts 804 and 806 stacked on top of each other. While the figure shows only one pocket on the right side of the mattress pad, there may be a corresponding pocket on the left side of the mattress. Further, each side of the mattress pad may have more than one pocket. The insert 804 is shown placed in an upper pocket 808, and the insert 806 is shown placed in a lower pocket 810. This allows the user to place two inserts, for instance, a cooling gel insert and a supportive coir insert, in the same area. As explained in FIG. 3 above, each insert may be filled with one of several different materials. Each pocket has its own closure mechanism e.g., buttons, zippers, hooks, Velcro® to temporarily seal in the insert. The pockets may have openings along sides, the top, or the bottom to allow for the inserts to be placed within the pad. A seam 812 runs down the middle of the customizable mattress pad 800 to keep the inserts from shifting. A similar seam separates the top and bottom layers and is more clearly visible in FIG. 10, which provides a side view of the customizable mattress pad 1000. A seam 1002 separates the left and right inserts and is shown as a seam 812 in FIG. 8. A layer 1004 made of the same material as the customizable mattress pad separates the top and bottom layer inserts shown using different patterns. A similar layer 1006 may also separate the bottom of the pad and the top of the mattress.

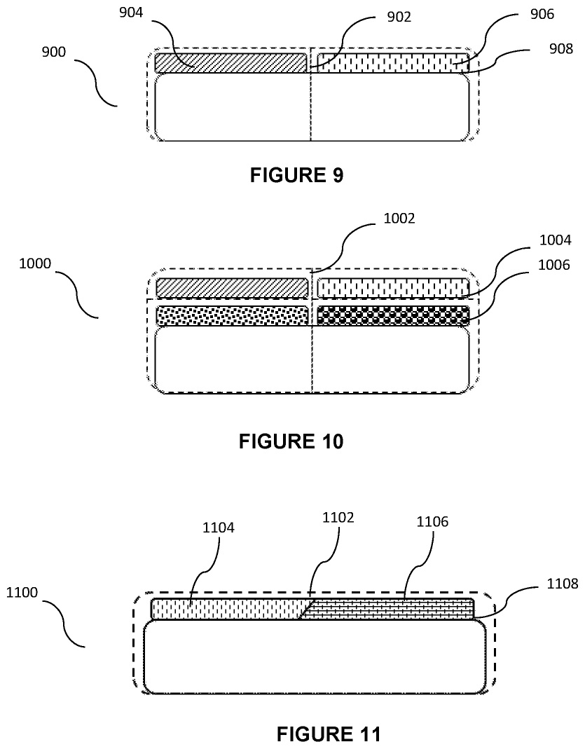

FIG. 9 shows a side view of the customizable mattress pad 900 with inserts 904 and 906. The inserts 904 and 906 are shown containing different fillings as represented by different patterns. A seam 902 is shown separating the left and right pockets such that the inserts 904 and 906 do not shift from their positions. A layer 908 made of the same material as the customizable mattress pad 900 separates the top and bottom layer inserts.

FIG. 11 shows a side view of the customizable mattress pad 1100 with inserts 1104 and 1106. The inserts 1104 and 1106 are shown containing different fillings as represented by different patterns. Instead of a seam, this embodiment has interlocking inserts. The inserts are shaped in a way that they overlap each other along one edge 1102. A layer 1108 made of the same material as the customizable mattress pad 1100 separates the mattress pad inserts from the mattress.

Although the invention is described herein with reference to various embodiments, one skilled in the art will readily appreciate that other applications may be substituted for those set forth herein without departing from the spirit and scope of the present invention. Accordingly, the invention should only be limited by the Claims included below.

1. A modular sleep apparatus, comprising:
at least two interlocking inserts configured to be placed above a mattress and underneath a fitted sheet;
said inserts comprising an interlocking mechanism for locking the inserts together;
said interlocking mechanism comprising any of snaps, buttons, zippers, hooks, and Velcro®;
said inserts comprising an attachment mechanism for attaching said inserts to the mattress;
said attachment mechanism comprising any of snaps, buttons, zippers, hooks, and Velcro®.

2. The modular sleep apparatus of claim 1, wherein the filling of the insert comprises any of a natural material; a synthetic material; a firm material; a soft material; a liquid contained within a resilient, leak proof enclosure; a heating material; and a cooling material.

3. The modular sleep apparatus of claim 1, wherein the inserts are inflatable.

4. The modular sleep apparatus of claim 1, wherein the inserts contain a vibrating motor.

5. A modular sleep apparatus, comprising:
a mattress comprising at least one pocket formed on a top surface thereof and along an outer seam;
at least one insert configured to completely fill the at least one pocket of the mattress when placed within said at least one pocket of the mattress pad.
